(19) United States
(12) Patent Application Publication
(10) Pub. No.: US 2026/0067345 A1
(43) Pub. Date: Mar. 5, 2026

(54) REAL-TIME TRANSPORT PROTOCOL HEADER COMPRESSION FOR TRANSPORT OVER A NON-TERRESTRIAL NETWORK

(71) Applicant: QUALCOMM Incorporated, San Diego, CA (US)

(72) Inventors: Akshay KUMAR, San Diego, CA (US); Arnaud MEYLAN, San Diego, CA (US); Sanjeev MITTAL, San Diego, CA (US)

(21) Appl. No.: 18/820,158

(22) Filed: Aug. 29, 2024

(51) Int. Cl. H04L 65/65; H04L 69/04; H04W 28/06

(52) U.S. Cl. CPC H04L 65/65; H04L 69/04; H04W 28/06

(57) ABSTRACT

Methods, systems, and devices for wireless communications are described. Techniques described provide for real-time transport protocol (RTP) header compression for transport over a non-terrestrial network (NTN). In some examples, a first network entity may receive, from a second network entity supported by the NTN, a first RTP packet comprising an audio payload associated with the second network entity, where the first RTP packet excludes one or more RTP header fields associated with an RTP packet generation protocol. The network entity may generate at least one RTP header field of the RTP header fields excluded from the first RTP packet. The first network entity may output, to a third network entity or to an upper layer RTP stack of the first network entity, a second RTP packet including the audio payload associated with the second network entity and the at least one RTP header field generated by the first network entity.

### FIELD OF TECHNOLOGY

The following relates to wireless communications, including real-time transport protocol header compression for transport over a non-terrestrial network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a first network entity is described. The method may include receiving, from a second network entity supported by a non-terrestrial network, a first real-time transport protocol (RTP) packet including an audio payload associated with the second network entity, where the first RTP packet excludes one or more RTP header fields associated with a packet generation according to an RTP packet generation protocol, generating at least one RTP header field of the one or more RTP header fields excluded from the first RTP packet based on exclusion of the one or more RTP header fields from the first RTP packet, and outputting, to a third network entity or to an upper layer RTP stack of the first network entity, a second RTP packet including both the audio payload associated with the second network entity and the at least one RTP header field generated by the first network entity.

A first network entity for wireless communication is described. The first network entity may include one or more memories storing processor executable code, and one or more processors coupled with the one or more memories. The one or more processors may individually or collectively be operable to execute the code to cause the first network entity to receive, from a second network entity supported by a non-terrestrial network, a first RTP packet including an audio payload associated with the second network entity, where the first RTP packet excludes one or more RTP header fields associated with a packet generation according to an RTP packet generation protocol, generate at least one RTP header field of the one or more RTP header fields excluded from the first RTP packet based on exclusion of the one or more RTP header fields from the first RTP packet, and output, to a third network entity or to an upper layer RTP stack of the first network entity, a second RTP packet including both the audio payload associated with the second network entity and the at least one RTP header field generated by the first network entity.

Another first network entity for wireless communication is described. The first network entity may include means for receiving, from a second network entity supported by a non-terrestrial network, a first RTP packet including an audio payload associated with the second network entity, where the first RTP packet excludes one or more RTP header fields associated with a packet generation according to an RTP packet generation protocol, means for generating at least one RTP header field of the one or more RTP header fields excluded from the first RTP packet based on exclusion of the one or more RTP header fields from the first RTP packet, and means for outputting, to a third network entity or to an upper layer RTP stack of the first network entity, a second RTP packet including both the audio payload associated with the second network entity and the at least one RTP header field generated by the first network entity.

A non-transitory computer-readable medium storing code for wireless communication is described. The code may include instructions executable by one or more processors to receive, from a second network entity supported by a non-terrestrial network, a first RTP packet including an audio payload associated with the second network entity, where the first RTP packet excludes one or more RTP header fields associated with a packet generation according to an RTP packet generation protocol, generate at least one RTP header field of the one or more RTP header fields excluded from the first RTP packet based on exclusion of the one or more RTP header fields from the first RTP packet, and output, to a third network entity or to an upper layer RTP stack of the first network entity, a second RTP packet including both the audio payload associated with the second network entity and the at least one RTP header field generated by the first network entity.

In some examples of the method, first network entities, and non-transitory computer-readable medium described herein, receiving the first RTP packet may include operations, features, means, or instructions for receiving, in the first RTP packet, a compressed RTP header that excludes the one or more RTP header fields associated with the RTP packet generation protocol.

In some examples of the method, first network entities, and non-transitory computer-readable medium described herein, the compressed RTP header may have a data size of one byte or the compressed RTP header may have the data size of zero.

In some examples of the method, first network entities, and non-transitory computer-readable medium described herein, receiving the compressed RTP header may include operations, features, means, or instructions for receiving one or more bits indicating a synchronization source identifier of the first RTP packet.

In some examples of the method, first network entities, and non-transitory computer-readable medium described herein, receiving the compressed RTP header may include operations, features, means, or instructions for receiving one or more bits associated with a sequence number of the first RTP packet.

In some examples of the method, first network entities, and non-transitory computer-readable medium described herein, receiving the compressed RTP header may include operations, features, means, or instructions for receiving one or more bits associated with a payload type associated with the first RTP packet.

In some examples of the method, first network entities, and non-transitory computer-readable medium described herein, the one or more RTP header fields excluded from the first RTP packet includes at least one of an RTP version identifier parameter associated with the first RTP packet, a padding indication parameter associated with the first RTP packet, an extension indication parameter associated with the first RTP packet, a contributor count parameter associated with the first RTP packet, or any combination thereof.

In some examples of the method, first network entities, and non-transitory computer-readable medium described herein, the one or more RTP header fields excluded from the first RTP packet includes a timestamp parameter associated with the first RTP packet.

In some examples of the method, first network entities, and non-transitory computer-readable medium described herein, the first RTP packet excludes an RTP header associated with the RTP packet generation protocol.

Some examples of the method, first network entities, and non-transitory computer-readable medium described herein may further include operations, features, means, or instructions for transmitting, to the second network entity prior to receiving the first RTP packet, an indication of the one or more RTP header fields excluded from the first RTP packet.

In some examples of the method, first network entities, and non-transitory computer-readable medium described herein, a variation in a time delay between a first time when the first RTP packet may be transmitted by the second network entity and a second time when the first packet may be received by the first network entity satisfies a threshold associated with an RTP packet interarrival duration.

In some examples of the method, first network entities, and non-transitory computer-readable medium described herein, a voice call hold feature may be unsupported based on exclusion of the one or more RTP header fields from the first RTP packet.

Some examples of the method, first network entities, and non-transitory computer-readable medium described herein may further include operations, features, means, or instructions for refraining from transmitting real-time transport control protocol (RTCP) feedback associated with the first RTP packet based on exclusion of the one or more RTP header fields from the first RTP packet.

Some examples of the method, first network entities, and non-transitory computer-readable medium described herein may further include operations, features, means, or instructions for transmitting, via the non-terrestrial network, RTCP feedback associated with the first RTP packet, where the RTCP feedback may be transmitted during a silence period of a voice call.

In some examples of the method, first network entities, and non-transitory computer-readable medium described herein, generating the at least one RTP header field may include operations, features, means, or instructions for generating at least one of a sequence number of the first RTP packet, a time stamp of the first RTP header, synchronization source identifier of the first RTP packet, or any combination thereof.

In some examples of the method, first network entities, and non-transitory computer-readable medium described herein, generating the at least one RTP header field may include operations, features, means, or instructions for generating an RTP version identifier parameter associated with the first RTP packet, a padding indication parameter associated with the first RTP packet, an extension indication parameter associated with the first RTP packet, a contributor count parameter associated with the first RTP packet, an end marker parameter associated with the first RTP packet, a payload type parameter associated with the first RTP packet, or any combination thereof.

In some examples of the method, first network entities, and non-transitory computer-readable medium described herein, the first network entity may be a user equipment, a network node, a base station, or a component of a disaggregated base station.

A method for wireless communication by a first network entity is described. The method may include receiving, from a second network entity supported by a non-terrestrial network, a first RTP packet including an audio payload associated with the second network entity, where the first RTP packet includes one or more RTP header fields associated with a packet generation according to an RTP packet generation protocol, generating a second RTP packet based on the first RTP packet, where the second RTP packet includes the audio payload and excludes one or more RTP header fields of the first RTP packet, and outputting, to a third network entity or to an upper layer RTP stack of the first network entity, the second RTP packet.

A first network entity for wireless communication is described. The first network entity may include one or more memories storing processor executable code, and one or more processors coupled with the one or more memories. The one or more processors may individually or collectively be operable to execute the code to cause the first network entity to receive, from a second network entity supported by a non-terrestrial network, a first RTP packet including an audio payload associated with the second network entity, where the first RTP packet includes one or more RTP header fields associated with a packet generation according to an RTP packet generation protocol, generate a second RTP packet based on the first RTP packet, where the second RTP packet includes the audio payload and excludes one or more RTP header fields of the first RTP packet, and output, to a third network entity or to an upper layer RTP stack of the first network entity, the second RTP packet.

Another first network entity for wireless communication is described. The first network entity may include means for receiving, from a second network entity supported by a non-terrestrial network, a first RTP packet including an audio payload associated with the second network entity, where the first RTP packet includes one or more RTP header fields associated with a packet generation according to an RTP packet generation protocol, means for generating a second RTP packet based on the first RTP packet, where the second RTP packet includes the audio payload and excludes one or more RTP header fields of the first RTP packet, and means for outputting, to a third network entity or to an upper layer RTP stack of the first network entity, the second RTP packet.

A non-transitory computer-readable medium storing code for wireless communication is described. The code may include instructions executable by one or more processors to receive, from a second network entity supported by a non-terrestrial network, a first RTP packet including an audio payload associated with the second network entity, where the first RTP packet includes one or more RTP header fields associated with a packet generation according to an RTP packet generation protocol, generate a second RTP packet based on the first RTP packet, where the second RTP packet includes the audio payload and excludes one or more RTP header fields of the first RTP packet, and output, to a third network entity or to an upper layer RTP stack of the first network entity, the second RTP packet.

In some examples of the method, first network entities, and non-transitory computer-readable medium described herein, generating the second RTP packet may include operations, features, means, or instructions for generating, in the second RTP packet, a compressed RTP header that excludes the one or more RTP header fields.

In some examples of the method, first network entities, and non-transitory computer-readable medium described herein, the compressed RTP header may have a data size of one byte or the compressed RTP header may have the data size of zero.

In some examples of the method, first network entities, and non-transitory computer-readable medium described herein, generating the compressed RTP header may include operations, features, means, or instructions for generating one or more bits indicating a synchronization source identifier of the first RTP packet.

In some examples of the method, first network entities, and non-transitory computer-readable medium described herein, generating the compressed RTP header may include operations, features, means, or instructions for generating one or more bits associated with a sequence number of the first RTP packet.

In some examples of the method, first network entities, and non-transitory computer-readable medium described herein, generating the compressed RTP header may include operations, features, means, or instructions for generating one or more bits associated with a payload type associated with the first RTP packet.

In some examples of the method, first network entities, and non-transitory computer-readable medium described herein, the one or more RTP header fields excluded of the first RTP packet includes at least one of an RTP version identifier parameter associated with the first RTP packet, a padding indication parameter associated with the first RTP packet, an extension indication parameter associated with the first RTP packet, a contributor count parameter associated with the first RTP packet, or any combination thereof.

In some examples of the method, first network entities, and non-transitory computer-readable medium described herein, the one or more RTP header fields excluded of the first RTP packet includes a timestamp parameter associated with the first RTP packet.

In some examples of the method, first network entities, and non-transitory computer-readable medium described herein, the second RTP packet excludes an RTP header associated with the RTP packet generation protocol.

In some examples of the method, first network entities, and non-transitory computer-readable medium described herein, a voice call hold feature may be unsupported based on exclusion of the one or more RTP header fields of the first RTP packet.

In some examples of the method, first network entities, and non-transitory computer-readable medium described herein, the first network entity may be a user equipment, a network node, a base station, or a component of a disaggregated base station Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports real-time transport protocol (RTP) header compression for transport over a non-terrestrial network in accordance with one or more aspects of the present disclosure.

FIG. 2 shows an example of a wireless communications system that supports RTP header compression for transport over a non-terrestrial network in accordance with one or more aspects of the present disclosure.

FIG. 3 shows an example of a wireless communications system that supports RTP header compression for transport over a non-terrestrial network in accordance with one or more aspects of the present disclosure.

FIG. 4 shows an example of a process flow that supports RTP header compression for transport over a non-terrestrial network in accordance with one or more aspects of the present disclosure.

FIGS. 5 and 6 show block diagrams of devices that support RTP header compression for transport over a non-terrestrial network in accordance with one or more aspects of the present disclosure.

FIG. 7 shows a block diagram of a communications manager that supports RTP header compression for transport over a non-terrestrial network in accordance with one or more aspects of the present disclosure.

FIG. 8 shows a diagram of a system including a UE that supports RTP header compression for transport over a non-terrestrial network in accordance with one or more aspects of the present disclosure.

FIG. 9 shows a diagram of a system including a network entity that supports RTP header compression for transport over a non-terrestrial network in accordance with one or more aspects of the present disclosure.

FIGS. 10 and 11 show flowcharts illustrating methods that support RTP header compression for transport over a non-terrestrial network in accordance with one or more aspects of the present disclosure.

### DETAILED DESCRIPTION

In some communication systems, a user equipment (UE) may communicate with a terrestrial network entity over a non-terrestrial network, such as via a satellite. In some cases, the UE may communicate audio data with the terrestrial network entity over the non-terrestrial network. The non-terrestrial network may have a low transmission data rate. In some cases, transmissions of real-time transport protocol (RTP) packets via the non-terrestrial network may reduce overhead by eliminating one or more of a user datagram protocol (UDP) header, an internet protocol (IP) header, and packet data convergence protocol (PDCP) header to reduce overhead. Audio data transmissions over the non-terrestrial network may benefit from a further reduction of the transmission overhead.

According to the techniques described herein, an RTP header may be compressed for transport over a non-terrestrial network to reduce transmission overhead. In some examples, the RTP header may be excluded from the RTP packet. In some cases, the network entity may receive, from the UE supported by the non-terrestrial network, a compressed RTP packet. The compressed RTP packet may include an audio payload associated with the first UE, and the compressed RTP packet may exclude one or more RTP header fields associated with an RTP packet generation protocol. In some cases, the compressed RTP packet may exclude the RTP header associated with the RTP packet generation protocol. The network entity may generate at least one RTP header field of the one or more RTP header fields excluded from the compressed RTP packet. The network entity may transmit, to a second UE, a RTP packet including the audio payload associated with the first UE and including the at least one RTP header field generated by the network entity.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to RTP header compression for transport over a non-terrestrial network.

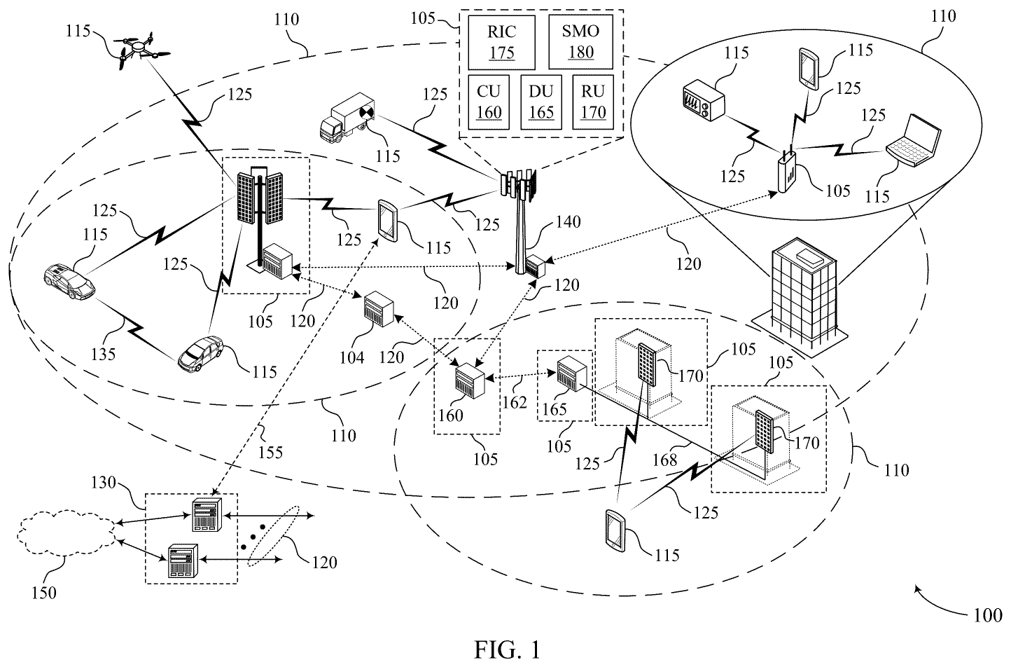

FIG. 1 shows an example of a wireless communications system 100 that supports RTP header compression for transport over a non-terrestrial network in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support RTP header compression for transport over a non-terrestrial network as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some communication systems, a UE 115 may communicate with a network entity 105 (which may support or be part of a terrestrial or non-terrestrial network) over a non-terrestrial network, such as via a satellite. In some cases, the UE 115 may communicate audio data with the network entity 105 over the non-terrestrial network. The non-terrestrial network may have a low transmission data rate. In some cases, transmissions of RTP packets via the non-terrestrial network may reduce overhead by eliminating one or more of a UDP header, an IP header, and PDCP header to reduce overhead. Audio data transmissions over the non-terrestrial network may benefit from a further reduction of the transmission overhead.

According to the techniques described herein, an RTP header may be compressed for transport over a non-terrestrial network to reduce transmission overhead. In some examples, the RTP header may be excluded from the RTP packet. In some cases, the network entity 105 may receive, from the UE 115 supported by the non-terrestrial network, a compressed RTP packet. The compressed RTP packet may include an audio payload associated with the UE 115, and the compressed RTP packet may exclude one or more RTP header fields associated with an RTP packet generation protocol. In some cases, the compressed RTP packet may exclude the RTP header associated with the RTP packet generation protocol. The network entity 105 may generate at least one RTP header field of the one or more RTP header fields excluded from the compressed RTP packet. The network entity 105 may transmit, to another UE 115, a RTP packet including the audio payload associated with the UE 115 and including the at least one RTP header field generated by the network entity 105.

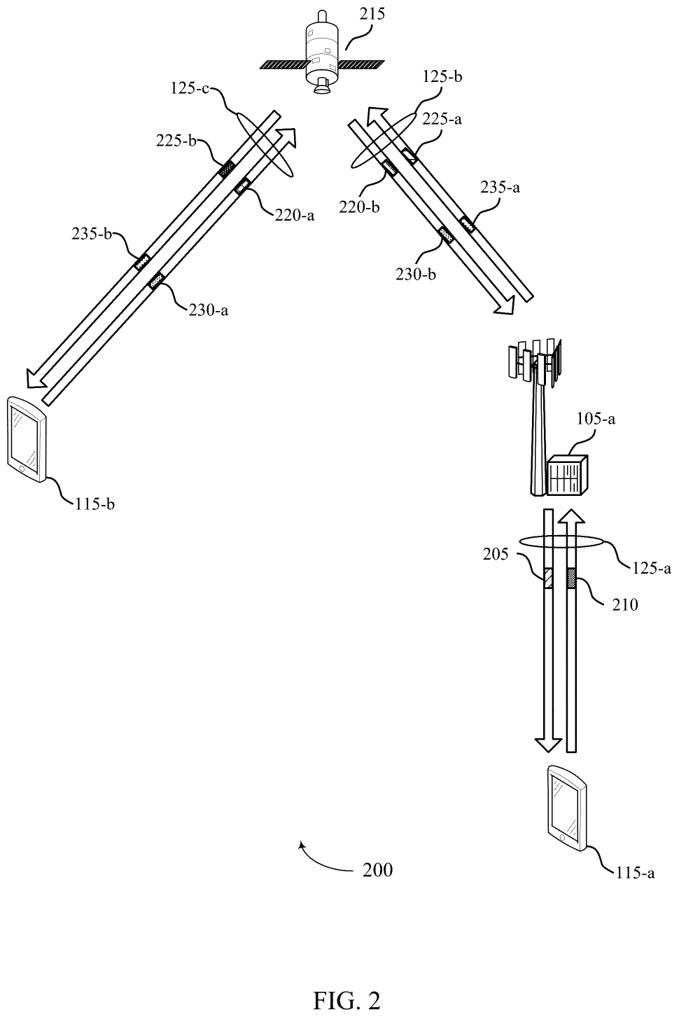

FIG. 2 shows an example of a wireless communications system 200 that supports RTP header compression for transport over a non-terrestrial network in accordance with one or more aspects of the present disclosure. The wireless communications system 200 may implement or may be implemented by aspects of the wireless communications system 100. For example, the wireless communications system 200 may include a UE 115a and a UE 115b, which may be an example of a UE 115 as described herein. The wireless communications system 200 may include a network entity 105a, which may be an example of a network entity 105 as described herein.

In some examples, the wireless communications system 200 may include an non-terrestrial network, a terrestrial network, or both. The UE 115a may communicate with the network entity 105a using a communication link 125a. For example, the UE 115a may be within a coverage area of a cell of a terrestrial cellular network. In some cases, the communication link 125a may be a communication link of a terrestrial network. The communication link 125a may be an example of a 6th generation (6G), a NR or LTE link between the UE 115a and the network entity 105a. The communication link 125a may include a bi-directional link that enable both uplink and downlink communications. For example, the UE 115a may transmit uplink signals 205 (e.g., uplink transmissions), such as uplink control signals or uplink data signals, to the network entity 105a using the communication link 125a and the network entity 105a may transmit downlink signals 210 (e.g., downlink transmissions), such as downlink control signals or downlink data signals, to the UE 115a using the communication link 125a.

In some examples, the UE 115b may communicate with the network entity 105a using a non-terrestrial network having a satellite 215. For example, the UE 115b may be outside a coverage area of a cell of a terrestrial cellular network, such as on a boat on the ocean, and the UE 115b may communicate with the network entity 105a using the satellite 215. The network entity 105a may be a network entity of the non-terrestrial network or of the terrestrial network. The satellite 215 may be referred to as a network entity 105 as illustrated by and described with reference to FIG. 1. The satellite 215 may relay communications between a network entity 105a and the UE 115b. For example, the network entity 105a may transmit one or more signals to the satellite 215 via the communication link 125b, and the satellite 215 may relay the one or more signals to the UE 115b via the communication link 125c. The communication link 125b and communication link 125-c may be an example of an LTE narrow band link or a 5G non-terrestrial network link. The communication link 125b and the communication link 125c a may include a bi-directional link that enable both uplink and downlink communications. For example, the UE 115a may transmit uplink signals 220a (e.g., uplink transmissions), such as uplink control signals or uplink data signals, to the network entity 105a using the communication link 125c and the satellite 215 may relay the uplink signals 220a as signals 220b to the network entity 105a using communication link 125b. The network entity 105a may transmit downlink signals 225 a (e.g., downlink transmissions), such as downlink control signals or downlink data signals, to the UE 115b using the communication link 125b and the satellite 215 may relay the downlink signals 225 a as signals 225 b to the UE 115b using communication link 125c.

In some examples, the UE 115b and the network entity 105a may communicate uplink signals and downlink signals associated with a voice call or audio over the non-terrestrial network. In some cases, the uplink data rate over the communication link 125b and communication link 125c may be between three kilobits per second (kbps) and six kbps. To support the audio payload associated with the voice call transmitted over the non-terrestrial network, an overhead associated with packet headers may be reduced across an entire protocol stack. In some cases, a non-internet-protocol data delivery (NIDD) architecture for LTE narrow band IoT may eliminate the transmission control protocol (TCP), UDP, IP and PDCP overhead. In some cases, the network entity 105a with an IMS media gateway may bridge the core network and the IMS network translating the NIDD bears to IP bearer as well as low bit rate non-terrestrial network codec to adaptive multi-rate wideband (AMR-WB) codec or enhanced voice services (EVS) codec. Even after eliminating the overhead associated with the UDP, IP, and PDCP layers, the protocol overhead for voice payload may benefit from a further reduction. For example, the RTP header may be approximately thirty-eight percent of the transport block (TB) size at a three kbps uplink physical channel. Maintaining the RTP header at twelve bytes (e.g., minimum header size according to an RTP packet generation protocol) may result in the RTP packets with an audio payload to be segmented that would incur extra satellite round trip time (RTT) per packet.

According to some aspects, the RTP header may be compressed or eliminated for transport over the non-terrestrial network to reduce transmission overhead. The compressed RTP header may be a separate header with one or more portions of the original RTP header or different portions relative to the original RTP header. For example, the UE 115b may transmit, to the network entity 105a supported by the satellite 215, an RTP packet (e.g., RTP packet 230a and RTP packet 230b) that includes an audio payload, such as from a voice call. The RTP packet (e.g., RTP packet 230a and RTP packet 230b) may exclude one or more RTP header fields associated with a packet generation according to an RTP packet generation protocol. In some cases, the RTP packet (e.g., RTP packet 230a and RTP packet 230b) may not include the RTP header (e.g., exclude the RTP header). In some cases, the network entity 105a may transmit, to the UE 115b supported by the satellite 215, an RTP packet (e.g., RTP packet 235a and RTP packet 235b) that includes an audio payload, such as from a voice call. The RTP packet (e.g., RTP packet 235a and RTP packet 235b) may exclude one or more RTP header fields associated with a packet generation according to an RTP packet generation protocol. In some cases, the RTP packet (e.g., RTP packet 235a and RTP packet 235b) may not include the RTP header.

In some cases, the RTP header, the UDP header, and the IP header may be compressed using a robust header compression (RoHC) algorithm. The RoHC algorithm may have two profiles: a first order (FO) state and a second order (SO) state. In the FO state, static fields of the header may be suppressed and differences may be transmitted for dynamic fields of the header. In the SO state, the compressor may suppress all dynamic fields, such as RTP sequence number (SN), time stamp (TS), and transmit a logical sequence number that causes the receiver side to predictively generate and verify the headers of the next expected packet. In the SO state, the quantity of bits of the RTP header may be greater than zero; in contrast, to the RTP packet without the RTP header that adds zero bits of overhead. For the RoHC, an uncompressed header may be transmitted at initialization and whenever context is lost due to decompression errors.

When the uncompressed header is transmitted over the low data rate non-terrestrial network (e.g., communication link 125b and communication link 125c), the voice payload may be segmented across multiple TBs increasing latency. In some cases, using a bidirectional reliable mode (R-mode) of the RoHC algorithm may avoid a loss of synchronization but may add more complexity at transmitter or receiver and may result in an intensive feedback channel that reduces a capacity for a downlink audio stream from the satellite 215 to UE 115b. The variable allowed payload in the TB due to change in RoHC states may mandate use of an RLC unacknowledged mode (RLC-UM) to allow for segmentation of voice payload. The RLC-UM header is four bytes of additional overhead. If the RTP header is omitted, the entire audio payload may fit in the TB and RLC transparent mode (RLC-TM) with no header may be implemented.

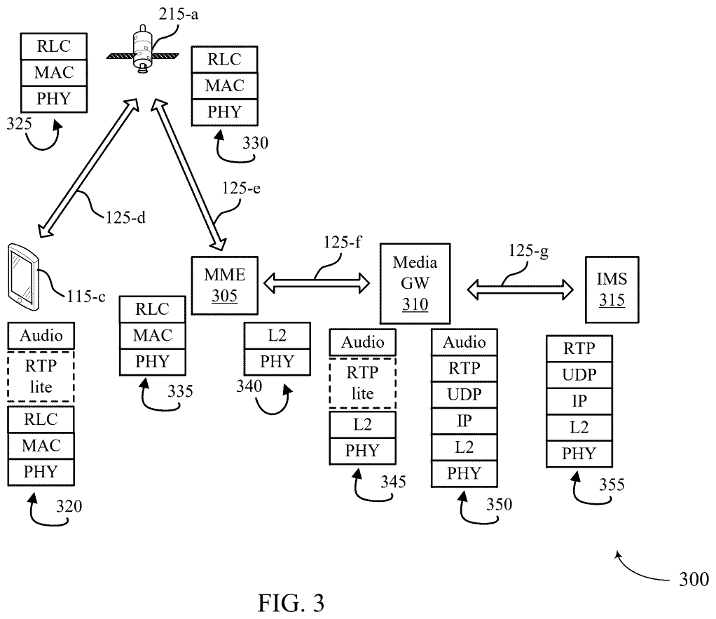

FIG. 3 shows an example of a wireless communications system 300 that supports RTP header compression for transport over a non-terrestrial network in accordance with one or more aspects of the present disclosure. The wireless communications system 300 may implement or may be implemented by aspects of the wireless communications system 100 and the wireless communications system 200. For example, the wireless communications system 300 may include a UE 115c, which may be an example of a UE 115 as described herein. The wireless communications system 300 may include a satellite 215-a, which may be an example of a satellite 215 as described herein.

In some examples, the wireless communications system 300 may include an MME 305, which may be an example of a network entity 105 as described herein or which may be a component of a network entity 105 as described herein. The wireless communications system 300 may include a media gateway 310, which may be an example of a network entity 105 as described herein or which may be a component of a network entity 105 as described herein. The wireless communications system 300 may include an IMS 315, which may be an example of a network entity 105 as described herein or which may be a component of a network entity 105 as described herein.

In the wireless communications system 300, the UE 115c may transmit one or more signals, data signal or control signals, to the satellite 215a via a communication link 125d, and the satellite 215a may relay the one or more signals to the MME 305 via the communication link 125e. The MME 305 may transmit one or more signals, data signals or control signals, to the satellite 215a via a communication link 125e, and the satellite 215a may relay the one or more signals to the UE 115c via the communication link 125d. The MME 305 may communicate with the media gateway 310 via the communication link 125f. The media gateway 310 may communicate with the IMS 315 via the communication link 125g. The communication link 125f and the communication link 125g may include bi-directional links that enable both uplink and downlink communications. For example, the MME 305 and the media gateway 310 may communicate control signals or data signals via communication link 125f, and the media gateway 310 and the IMS 315 may communicate control signals or data signals via the communication link 125g. Although not shown in FIG. 3, the IMS 315 may communicate with a UE via a communication link, such as a 6G, a NR or LTE link, between the IMS 315 and the UE.

In some cases, the wireless communications system 300 may enable voice over LTE that enables voice calls over the LTE network. The wireless communications system 300 may implement at least portions of an LTE narrow band control plane cellular IoT (LTE NB CP-CIoT) architecture for voice data transmission over the satellite 215a. In some cases, the wireless communications system 300 may implement at least portions of a user plane cellular IoT (UP-IoT) architecture. In some examples, to reduce the transmission overhead of the voice data transmission, the headers associated with different layers of the voice data transmission may be eliminated or compressed. For example, at the UE 115c, the voice data transmission may include headers 320 for the audio layer, the RLC layer, the MAC layer, and the physical layer. At the UE 115c, the header of the UDPUDP layer and the header of IP layer may be eliminated. In some examples, the header of the RTP layer may be eliminated (e.g., no RTP header) or the header of the RTP layer may be compressed (e.g., RTP lite header with one or more RTP header fields being excluded from the RTP header). At the satellite 215a, the voice data transmission may include headers 325 and headers 330 for the RLC layer, the MAC layer, and the physical layer and may not include headers for the UDP layer and the IP layer. At the MME 305 for CP-IoT or at a packet gateway for UP-IoT, the voice data transmission received from or transmitted the satellite 215a may include headers 335 for the RLC layer, MAC layer, and the physical layer and may not include headers for the UDP layer and the IP layer. At the MME 305, the voice data transmission received from or transmitted the media gateway 310 may include headers 340 for the L2 layer and the physical layer and may not include headers for the UDP layer and the IP layer. At the media gateway 310, the voice data transmission received from or transmitted the MME 305 may include headers 345 for the audio layer, the L2 layer and the physical layer and may not include headers for the UDP layer and the IP layer. In some cases, at the media gateway 310, the voice data transmission received from or transmitted the MME 305 may include the compressed RTP header (e.g., RTP lite header with one or more RTP header fields being excluded from the RTP header or with one or more RTP header fields being modified). At the media gateway 310, the voice data transmission received from or transmitted the IMS 315 may include headers 350 for the audio layer, RTP layer, UDP layer, IP layer, L2 layer and the physical layer. At the IMS 315, the voice data transmission received from or transmitted the media gateway 310 may include headers 355 for the RTP layer, UDP layer, IP layer, L2 layer and the physical layer.

In some examples, the UE 115c and the media gateway 310 may agree to communicate without the RTP header or with the compressed RTP header. For example, the media gateway 310 or other network entity may transmit, to the UE 115c, an indication or control signaling indicating communications without the RTP header. In some cases, the media gateway 310 or other network entity may transmit, to the UE 115c, an indication or control signaling indicating communications with the compressed RTP header. For example, the media gateway 310 or other network entity may transmit, to the UE 115c, an indication of the one or more RTP header fields excluded from the RTP packet.

For the voice call originating at the non-terrestrial network UE (e.g., UE 115c), a UE IMS transmitter of the UE 115c may operate in a bypass mode, may skip RTP header generation, and may forward encoded audio to the modem. For the voice call originating at the non-terrestrial network UE (e.g., UE 115c), the media gateway 310 may terminate the protocol stack at the audio layer. After non-terrestrial network to terrestrial network vocoder transcoding, the media gateway 310 may add the RTP header (along with other headers, such as UDP header and the IP header) and may forward the voice packet to IMS 315 or VoIP network. The IMS 315 may forward the voice packet to the far end UE or to another device. If the voice transmission excluded the RTP header, the media gateway 310 may add the RTP header. If the voice transmission included the compressed RTP header, the media gateway 310 may add or expand the one or more excluded RTP header fields to the RTP header.

For a voice call terminating at the non-terrestrial network UE (e.g., UE 115c), after terrestrial network to non-terrestrial network vocoder transcoding, the media gateway 310 may skip or exclude the RTP header, the UDP header, the IP headers and may push the encoded audio to the L2 layer. In some cases, the media gateway 310 may compress the RTP header to exclude one or more of the RTP header fields. At the UE 115c, the UE IMS receiver may pass through the received audio payload, and the voice payload may be sent to audio.

In some cases, the transmission of the RTP packet without the RTP header may be implemented if the jitter between the UE 115c and the media gateway 310 is less than the RTP packet interarrival time (e.g., 20, 40, or 80 ms), so out of order packet arrival may not be possible. When the jitter or a variation in a time delay between a first time when the RTP packet is transmitted by the UE 115c and a second time when the RTP packet is received by the media gateway 310 satisfies a threshold associated with an RTP packet interarrival durations, the dejitter buffer, the RTP sequence number field of the RTP header or the timestamp field of the RTP header may not be used at the media gateway receiver for a mobile originated call (MO call) or a mobile terminated call (MT call). In some cases, the exclusion of the dejitter buffer, the RTP sequence number field of the RTP header or the timestamp field of the RTP header may be achieved if no packet retransmissions are implemented (e.g., HARQ may be disabled and RLC UM or TM mode may be used). A voice call hold feature may be unsupported based on exclusion of the RTP header, so that a call identifier (e.g., synchronization source identifier (SSRC)) may be excluded from the RTP header. In some cases, real-time transport control protocol (RTCP) feedback may not be communicated between the UE 115c and the media gateway 310 based on exclusion of the RTP header, so the UE 115c and the media gateway 310 may not track sequence numbers of lost RTP packets on the non-terrestrial network uplink or downlink communications or the delay and jitter, which are computed using time stamps or information indicating arrival time in RTP header.

In some examples, the media gateway 310 may generate or regenerate the RTP header fields of the excluded RTP header or RTP fields excluded from the compressed RTP header. In some cases, another UE may receive RTP packet and may generate or regenerate the RTP header fields of the excluded RTP header or RTP fields excluded from the compressed RTP header. For example, the UE may receive the RTP packet from the UE 115-c. The UE middleware of the UE may generate or regenerate the RTP header fields of the excluded RTP header or RTP fields excluded from the compressed RTP header such that off the shelf RTP/UDP/IP stack may interpret the payload. For example, the media gateway 310 (or UE) may generate a identifier parameter of the RTP header as a two bit field set to the value of the latest version of the RTP packet generation protocol. The media gateway 310 (or UE) may generate a padding indication parameter (P) of the RTP header as a one bit field set to zero. The media gateway 310 (or UE) may generate an extension indication parameter (X) of the RTP header as a one bit field set to zero. The media gateway 310 (or UE) may generate a contributor count parameter (CC) of the RTP header as a four bit field set to zero. The media gateway 310 (or UE) may generate an end marker parameter (M) of the RTP header as a one bit field set to one at the start of the talk spurt or else set to zero. The media gateway 310 (or UE) may generate a payload type parameter (PT) of the RTP header according to known payload types or payload types negotiated via the session description protocol (SDP). The media gateway 310 (or UE) may generate a sequence number by assigning sequence numbers to RTP packets in a first-in-first-out manner. The media gateway 310 (or UE) may generate a time stamp as a four byte field by randomly selecting the time stamp for a first RTP packet and thereafter, for future RTP headers, by incrementing the timestamp by an audio frame duration*10-3*clock_freq_hz where clock_freq_hz is uniquely defined per payload type (e.g., the payload type refers to the vocoder selected by media gateway 310 after transcoding). The media gateway 310 (or UE) may generate a SSRC as a four byte field by selecting a random identifier on behalf of the UE 115c using an message-digest algorithm (MD5) routine of the RTP packet generation protocol. Once selected, the SSRC may not change for an RTP session. The SSRC in the transmitter and the receiver direction may be different since the SSRC are either used by receiving UE or the transmitting media gateway but not used by both the receiving UE or the transmitting media gateway. In some cases, the media gateway 310 may transmit, to another UE, a second RTP packet including both the audio payload associated with the UE 115-c and the RTP header fields generated by the media gateway 310. In some examples, the UE may output, to an upper layer RTP stack, a second RTP packet including both the audio payload associated with the UE 115-c and the RTP header fields generated by the UE.

In some examples, the non-terrestrial network may support multiple concurrent active voice calls, and a few bits in the RTP header may be used to differentiate the call for which RTP packets are flowing between UE 115c and media gateway 310. When a voice call is put one hold, a duration may occur for voice packets from the far end to arrive at the MO UE, and the voice packets may be identified and then discarded by the MO UE audio module to avoid cross-talk between two calls. In some examples, the compressed RTP header may be one byte replacing a twelve byte header of the RTP packet generation protocol. In some examples, the compressed RTP header (e.g., RTP lite header with one or more RTP header fields being excluded from the RTP header) may have a data size of one byte. The compressed RTP header may reserve two bits for a call identifier (e.g., SSRC) that may support up to three hold calls and one active voice call. The thirty-two bit SSRC identifier may not be used as the media gateway 310 may keep track of the multiple calls and call identifier collision may not be possible. The media gateway 310 may map each local call identifier to a thirty-two bit SSRC identifier before forwarding to the IMS core network (e.g., IMS 315). The UE and media gateway may use a protocol to allocate the compressed SSRC in order to avoid collisions, considering the bit-width is reduced. In some cases, the compressed RTP header may reserve six bits for signaling RTP sequence number between the UE 115c and the media gateway 310 to help track packet losses in satellite uplink and downlink. The packet loss may be detected by media gateway 310 and merged with RTCP feedback received from the far end UE. In some cases, for MT calls, the six bit RTP SN may help the UE 115c detect additional packet loss in media gateway 310 to MME 305 to satellite 215a to UE 115c link. The UE 115c may signal the packet loss to media gateway 310, and the media gateway 310 may merge the packet loss from the UE 115c with a local RTCP report and transmit the RTCP report to far end UE. In some cases, some of the other RTP header fields may be included, or a subset of the RTP header fields may be included (e.g., padding bit). In some cases, the RTCP feedback may be transmitted during a silence period of a voice call to avoid contention for limited uplink capacity during a talk spurt.

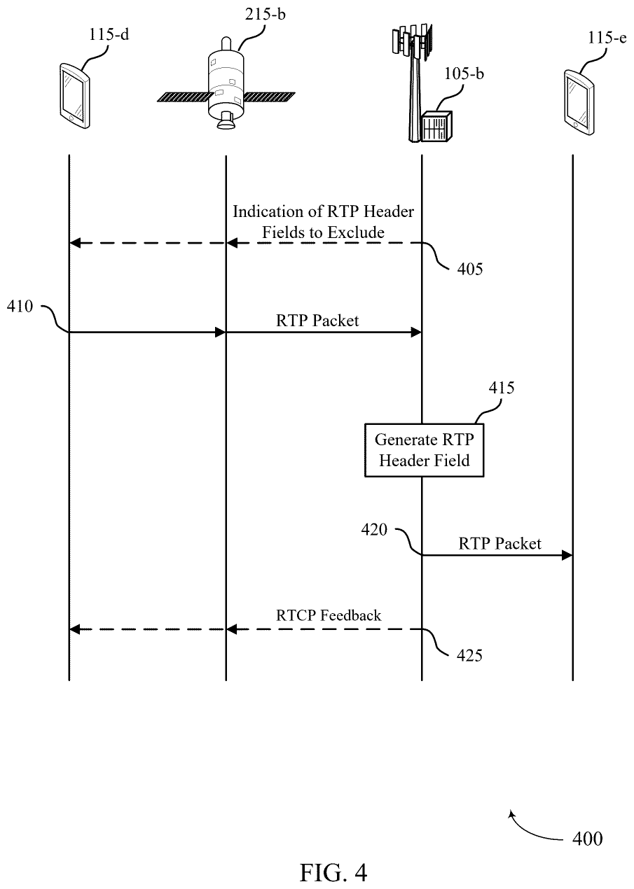

FIG. 4 shows an example of a process flow 400 that supports RTP header compression for transport over a non-terrestrial network in accordance with one or more aspects of the present disclosure. The process flow 400 may implement or may be implemented by aspects of the wireless communications system 100, the wireless communications system 200, or the wireless communications system 300. For example, the process flow 400 may include a UE 115-d and a UE 115-e, which may be an example of a UE 115 as described herein. The process flow 400 may include a network entity 105-b, which may be an example of a network entity 105 as described herein. The process flow 400 may include a satellite 215-b, which may be an example of a satellite as described herein. In the following description of the process flow 400, the operations between the network entity 105-b, the UE 115-d, and the UE 115-e may be transmitted in a different order than the example order shown, or the operations performed by the network entity 105-b, the UE 115-d, and UE 115-e may be performed in different orders or at different times. Some operations may also be omitted from the process flow 400, and other operations may be added to the process flow 400.

At 405, the network entity 105-b may transmit, to the UE 115-d supported by the non-terrestrial network (e.g., satellite 215-b), an indication of one or more RTP header fields excluded from a first RTP packet.

At 410, the network entity 105-b may receive, from UE 115-d supported by the non-terrestrial network (e.g., satellite 215-b), the first RTP packet including an audio payload associated with the UE 115-d. The first RTP packet may exclude one or more RTP header fields associated with an RTP packet generation protocol. In some examples, the network entity 105-b may receive, in the first RTP packet, a compressed RTP header that excludes the one or more RTP header fields associated with the RTP packet generation protocol. In some examples, the compressed RTP header may have a data size of one byte. In some cases, receiving the compressed RTP header may include receiving one or more bits indicating a synchronization source identifier of the compressed RTP packet. In some cases, receiving the compressed RTP header may include receiving one or more bits associated with a sequence number of the compressed RTP packet. In some cases, receiving the compressed RTP header may include receiving one or more bits indicating a payload type associated with the compressed RTP packet.

In some examples, the one or more RTP header fields excluded from the first RTP packet may include an RTP version identifier parameter associated with the first RTP packet, a padding indication parameter associated with the first RTP packet, an extension indication parameter associated with the first RTP packet, a contributor count parameter associated with the first RTP packet, or any combination thereof. In some cases, the one or more RTP header fields excluded from the first RTP packet may include a timestamp parameter associated with the first RTP packet. In some examples, the first RTP packet may exclude an RTP header associated with the RTP packet generation protocol. In some cases, a voice call hold may be unsupported based on exclusion of the one or more RTP header fields from the first RTP packet.

In some examples, a variation in a time delay between a first time when the first RTP packet is transmitted by the UE 115-d and a second time when the first RTP packet is received by the network entity 105-b satisfy a threshold associated with an RTP packet interarrival duration. In some cases, the network entity 105-b may refrain from transmitting RTCP feedback associated with the first RTP packet based on exclusion of the one or more RTP header fields from the first RTP packet.

At 415, the network entity 105-b may generate at least one RTP header field of the one or more RTP header fields excluded from the first RTP packet based on exclusion of the one or more RTP header fields from the first RTP packet. In some examples, the network entity 105-a may generate at least one of a sequence number of the first RTP packet, a time stamp of the first RTP header, synchronization source identifier of the first RTP packet, or any combination thereof. In some cases, the network entity 105-b may generate an RTP version identifier parameter associated with the first RTP packet, a padding indication parameter associated with the first RTP packet, an extension indication parameter associated with the first RTP packet, a contributor count parameter associated with the first RTP packet, an end marker parameter associated with the first RTP packet, a payload type parameter associated with the first RTP packet, or any combination thereof.

At 420, the network entity 105-b may transmit, to the UE 115-e, a second RTP packet including the audio payload associated with the UE 115-d and including the at least one RTP header field generated by the network entity 105-b.

At 425, the network entity may transmit, via the non-terrestrial network, RTCP feedback associated with the first RTP packet, where the RTCP feedback is transmitted during a silence period of a voice call.

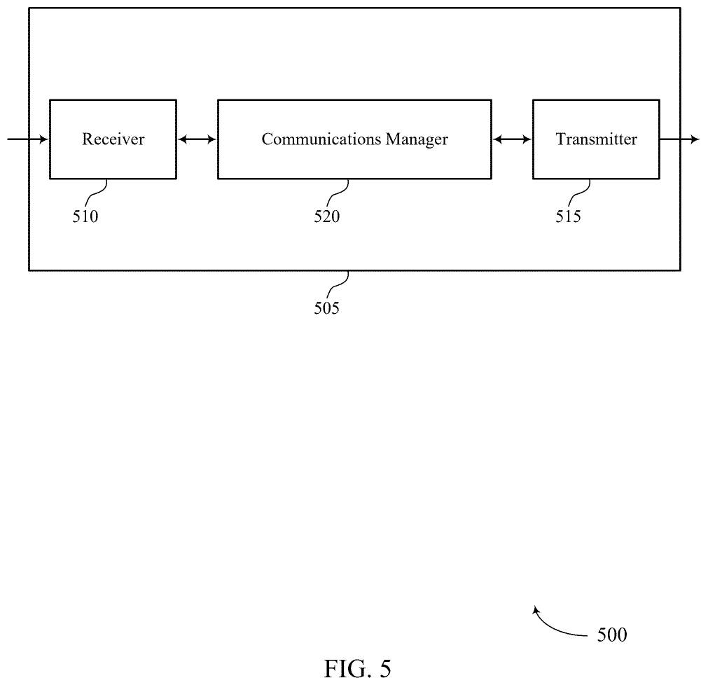

FIG. 5 shows a block diagram 500 of a device 505 that supports RTP header compression for transport over a non-terrestrial network in accordance with one or more aspects of the present disclosure. The device 505 may be an example of aspects of a UE 115 or a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to RTP header compression for transport over a non-terrestrial network). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to RTP header compression for transport over a non-terrestrial network). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of RTP header compression for transport over a non-terrestrial network as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 is capable of, configured to, or operable to support a means for receiving, from a second network entity supported by a non-terrestrial network, a first RTP packet including an audio payload associated with the second network entity, where the first RTP packet excludes one or more RTP header fields associated with a packet generation according to an RTP packet generation protocol. The communications manager 520 is capable of, configured to, or operable to support a means for generating at least one RTP header field of the one or more RTP header fields excluded from the first RTP packet based on exclusion of the one or more RTP header fields from the first RTP packet. The communications manager 520 is capable of, configured to, or operable to support a means for outputting, to a third network entity or to an upper layer RTP stack of the first network entity, a second RTP packet including both the audio payload associated with the second network entity and the at least one RTP header field generated by the first network entity.

Additionally, or alternatively, the communications manager 520 may support wireless communication in accordance with examples as disclosed herein. For example, the communications manager 520 is capable of, configured to, or operable to support a means for receiving, from a second network entity supported by a non-terrestrial network, a first RTP packet including an audio payload associated with the second network entity, where the first RTP packet includes one or more RTP header fields associated with a packet generation according to an RTP packet generation protocol. The communications manager 520 is capable of, configured to, or operable to support a means for generating a second RTP packet based on the first RTP packet, where the second RTP packet includes the audio payload and excludes one or more RTP header fields of the first RTP packet. The communications manager 520 is capable of, configured to, or operable to support a means for outputting, to a third network entity or to an upper layer RTP stack of the first network entity, the second RTP packet.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

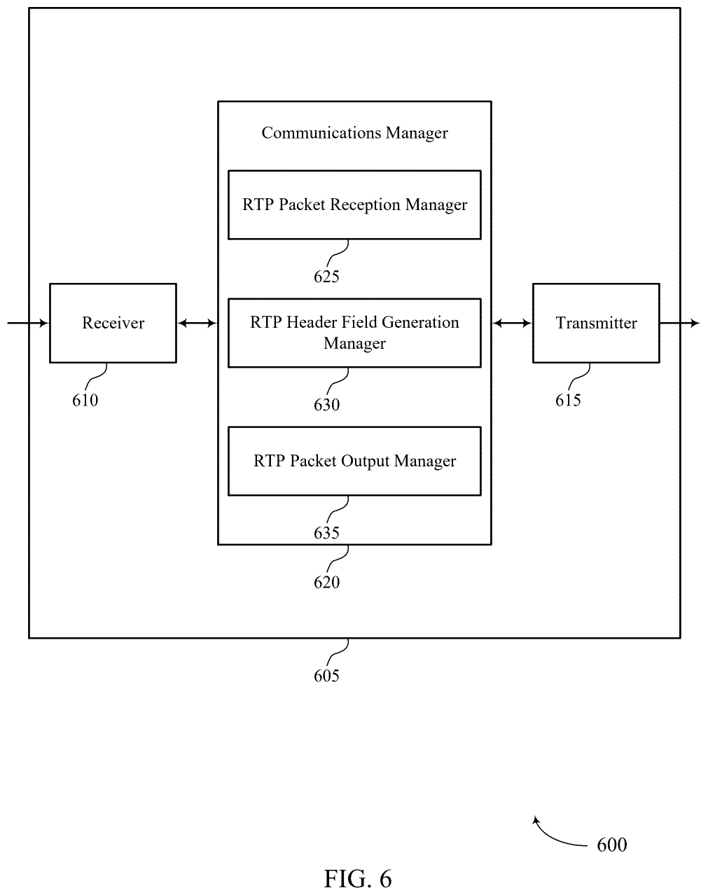

FIG. 6 shows a block diagram 600 of a device 605 that supports RTP header compression for transport over a non-terrestrial network in accordance with one or more aspects of the present disclosure. The device 605 may be an example of aspects of a device 505, a UE 115, or a network entity 105 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to RTP header compression for transport over a non-terrestrial network). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RTP header compression for transport over a non-terrestrial network). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of RTP header compression for transport over a non-terrestrial network as described herein. For example, the communications manager 620 may include an RTP packet reception manager 625, an RTP header field generation manager 630, an RTP packet output manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The RTP packet reception manager 625 is capable of, configured to, or operable to support a means for receiving, from a second network entity supported by a non-terrestrial network, a first RTP packet including an audio payload associated with the second network entity, where the first RTP packet excludes one or more RTP header fields associated with a packet generation according to an RTP packet generation protocol. The RTP header field generation manager 630 is capable of, configured to, or operable to support a means for generating at least one RTP header field of the one or more RTP header fields excluded from the first RTP packet based on exclusion of the one or more RTP header fields from the first RTP packet. The RTP packet output manager 635 is capable of, configured to, or operable to support a means for outputting, to a third network entity or to an upper layer RTP stack of the first network entity, a second RTP packet including both the audio payload associated with the second network entity and the at least one RTP header field generated by the first network entity.

Additionally, or alternatively, the communications manager 620 may support wireless communication in accordance with examples as disclosed herein. The RTP packet reception manager 625 is capable of, configured to, or operable to support a means for receiving, from a second network entity supported by a non-terrestrial network, a first RTP packet including an audio payload associated with the second network entity, where the first RTP packet includes one or more RTP header fields associated with a packet generation according to an RTP packet generation protocol. The RTP header field generation manager 630 is capable of, configured to, or operable to support a means for generating a second RTP packet based on the first RTP packet, where the second RTP packet includes the audio payload and excludes one or more RTP header fields of the first RTP packet. The RTP packet output manager 635 is capable of, configured to, or operable to support a means for outputting, to a third network entity or to an upper layer RTP stack of the first network entity, the second RTP packet.

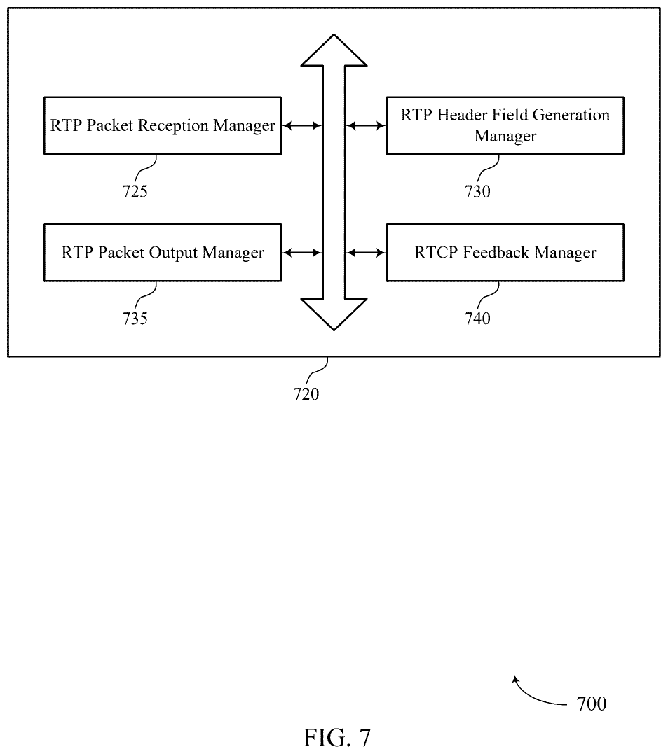

FIG. 7 shows a block diagram 700 of a communications manager 720 that supports RTP header compression for transport over a non-terrestrial network in accordance with one or more aspects of the present disclosure. The communications manager 720 may be an example of aspects of a communications manager 520, a communications manager 620, or both, as described herein. The communications manager 720, or various components thereof, may be an example of means for performing various aspects of RTP header compression for transport over a non-terrestrial network as described herein. For example, the communications manager 720 may include an RTP packet reception manager 725, an RTP header field generation manager 730, an RTP packet output manager 735, an RTCP feedback manager 740, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communication in accordance with examples as disclosed herein. The RTP packet reception manager 725 is capable of, configured to, or operable to support a means for receiving, from a second network entity supported by a non-terrestrial network, a first RTP packet including an audio payload associated with the second network entity, where the first RTP packet excludes one or more RTP header fields associated with a packet generation according to an RTP packet generation protocol. The RTP header field generation manager 730 is capable of, configured to, or operable to support a means for generating at least one RTP header field of the one or more RTP header fields excluded from the first RTP packet based on exclusion of the one or more RTP header fields from the first RTP packet. The RTP packet output manager 735 is capable of, configured to, or operable to support a means for outputting, to a third network entity or to an upper layer RTP stack of the first network entity, a second RTP packet including both the audio payload associated with the second network entity and the at least one RTP header field generated by the first network entity.

In some examples, to support receiving the first RTP packet, the RTP packet reception manager 725 is capable of, configured to, or operable to support a means for receiving, in the first RTP packet, a compressed RTP header that excludes the one or more RTP header fields associated with the RTP packet generation protocol.

In some examples, the compressed RTP header has a data size of one byte or the compressed RTP header has the data size of zero.

In some examples, to support receiving the compressed RTP header, the RTP packet reception manager 725 is capable of, configured to, or operable to support a means for receiving one or more bits indicating a synchronization source identifier of the first RTP packet.

In some examples, to support receiving the compressed RTP header, the RTP packet reception manager 725 is capable of, configured to, or operable to support a means for receiving one or more bits associated with a sequence number of the first RTP packet.

In some examples, to support receiving the compressed RTP header, the RTP packet reception manager 725 is capable of, configured to, or operable to support a means for receiving one or more bits associated with a payload type associated with the first RTP packet.

In some examples, the one or more RTP header fields excluded from the first RTP packet includes at least one of an RTP version identifier parameter associated with the first RTP packet, a padding indication parameter associated with the first RTP packet, an extension indication parameter associated with the first RTP packet, a contributor count parameter associated with the first RTP packet, or any combination thereof.

In some examples, the one or more RTP header fields excluded from the first RTP packet includes a timestamp parameter associated with the first RTP packet.

In some examples, the first RTP packet excludes an RTP header associated with the RTP packet generation protocol.

In some examples, the RTP header field generation manager 730 is capable of, configured to, or operable to support a means for transmitting, to the second network entity prior to receiving the first RTP packet, an indication of the one or more RTP header fields excluded from the first RTP packet.

In some examples, a variation in a time delay between a first time when the first RTP packet is transmitted by the second network entity and a second time when the first packet is received by the first network entity satisfies a threshold associated with an RTP packet interarrival duration.

In some examples, a voice call hold feature is unsupported based on exclusion of the one or more RTP header fields from the first RTP packet.

In some examples, the RTCP feedback manager 740 is capable of, configured to, or operable to support a means for refraining from transmitting real-time transport control protocol (RTCP) feedback associated with the first RTP packet based on exclusion of the one or more RTP header fields from the first RTP packet.

In some examples, the RTCP feedback manager 740 is capable of, configured to, or operable to support a means for transmitting, via the non-terrestrial network, real-time transport control protocol (RTCP) feedback associated with the first RTP packet, where the RTCP feedback is transmitted during a silence period of a voice call.

In some examples, to support generating the at least one RTP header field, the RTP header field generation manager 730 is capable of, configured to, or operable to support a means for generating at least one of a sequence number of the first RTP packet, a time stamp of the first RTP header, synchronization source identifier of the first RTP packet, or any combination thereof.

In some examples, to support generating the at least one RTP header field, the RTP header field generation manager 730 is capable of, configured to, or operable to support a means for generating an RTP version identifier parameter associated with the first RTP packet, a padding indication parameter associated with the first RTP packet, an extension indication parameter associated with the first RTP packet, a contributor count parameter associated with the first RTP packet, an end marker parameter associated with the first RTP packet, a payload type parameter associated with the first RTP packet, or any combination thereof.

In some examples, the first network entity is a user equipment, a network node, a base station, or a component of a disaggregated base station.

Additionally, or alternatively, the communications manager 720 may support wireless communication in accordance with examples as disclosed herein. In some examples, the RTP packet reception manager 725 is capable of, configured to, or operable to support a means for receiving, from a second network entity supported by a non-terrestrial network, a first RTP packet including an audio payload associated with the second network entity, where the first RTP packet includes one or more RTP header fields associated with a packet generation according to an RTP packet generation protocol. In some examples, the RTP header field generation manager 730 is capable of, configured to, or operable to support a means for generating a second RTP packet based on the first RTP packet, where the second RTP packet includes the audio payload and excludes one or more RTP header fields of the first RTP packet. In some examples, the RTP packet output manager 735 is capable of, configured to, or operable to support a means for outputting, to a third network entity or to an upper layer RTP stack of the first network entity, the second RTP packet.

In some examples, to support generating the second RTP packet, the RTP header field generation manager 730 is capable of, configured to, or operable to support a means for generating, in the second RTP packet, a compressed RTP header that excludes the one or more RTP header fields.

In some examples, the compressed RTP header has a data size of one byte or the compressed RTP header has the data size of zero.

In some examples, to support generating the compressed RTP header, the RTP header field generation manager 730 is capable of, configured to, or operable to support a means for generating one or more bits indicating a synchronization source identifier of the first RTP packet.

In some examples, to support generating the compressed RTP header, the RTP header field generation manager 730 is capable of, configured to, or operable to support a means for generating one or more bits associated with a sequence number of the first RTP packet.

In some examples, to support generating the compressed RTP header, the RTP header field generation manager 730 is capable of, configured to, or operable to support a means for generating one or more bits associated with a payload type associated with the first RTP packet.

In some examples, the one or more RTP header fields excluded of the first RTP packet includes at least one of an RTP version identifier parameter associated with the first RTP packet, a padding indication parameter associated with the first RTP packet, an extension indication parameter associated with the first RTP packet, a contributor count parameter associated with the first RTP packet, or any combination thereof.

In some examples, the one or more RTP header fields excluded of the first RTP packet includes a timestamp parameter associated with the first RTP packet.

In some examples, the second RTP packet excludes an RTP header associated with the RTP packet generation protocol.

In some examples, a voice call hold feature is unsupported based on exclusion of the one or more RTP header fields of the first RTP packet.

In some examples, the first network entity is a user equipment, a network node, a base station, or a component of a disaggregated base station.

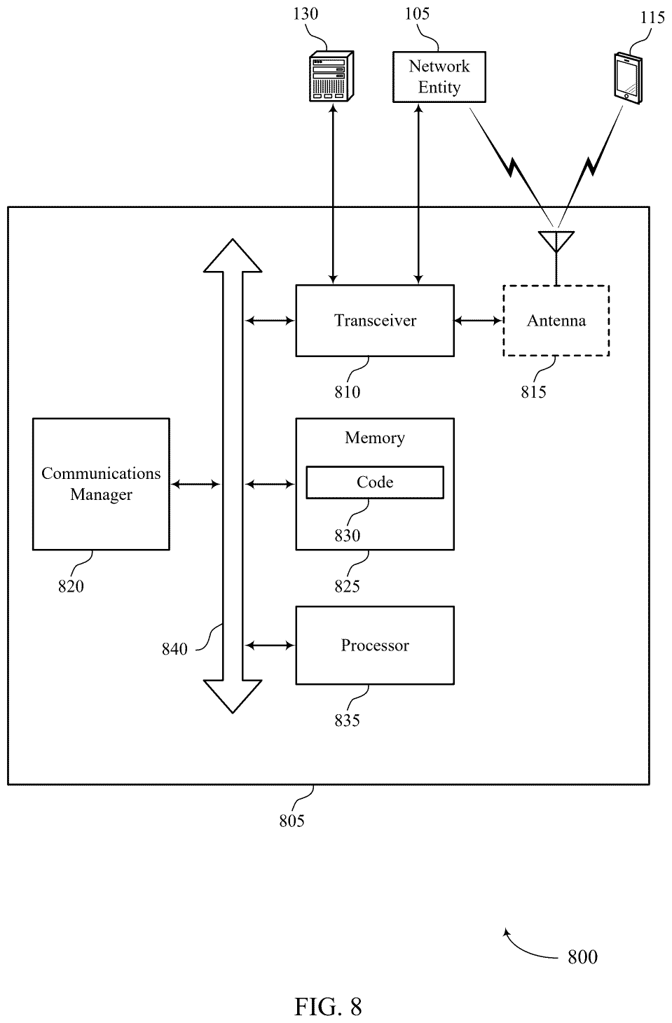

FIG. 8 shows a diagram of a system 800 including a device 805 that supports RTP header compression for transport over a non-terrestrial network in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include random access memory (RAM), read-only memory (ROM), or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a basic input/output (I/O) system (BIOS) which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting RTP header compression for transport over a non-terrestrial network). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communication in accordance with examples as disclosed herein. For example, the communications manager 820 is capable of, configured to, or operable to support a means for receiving, from a second network entity supported by a non-terrestrial network, a first RTP packet including an audio payload associated with the second network entity, where the first RTP packet excludes one or more RTP header fields associated with a packet generation according to an RTP packet generation protocol. The communications manager 820 is capable of, configured to, or operable to support a means for generating at least one RTP header field of the one or more RTP header fields excluded from the first RTP packet based on exclusion of the one or more RTP header fields from the first RTP packet. The communications manager 820 is capable of, configured to, or operable to support a means for outputting, to a third network entity or to an upper layer RTP stack of the first network entity, a second RTP packet including both the audio payload associated with the second network entity and the at least one RTP header field generated by the first network entity.

Additionally, or alternatively, the communications manager 820 may support wireless communication in accordance with examples as disclosed herein. For example, the communications manager 820 is capable of, configured to, or operable to support a means for receiving, from a second network entity supported by a non-terrestrial network, a first RTP packet including an audio payload associated with the second network entity, where the first RTP packet includes one or more RTP header fields associated with a packet generation according to an RTP packet generation protocol. The communications manager 820 is capable of, configured to, or operable to support a means for generating a second RTP packet based on the first RTP packet, where the second RTP packet includes the audio payload and excludes one or more RTP header fields of the first RTP packet. The communications manager 820 is capable of, configured to, or operable to support a means for outputting, to a third network entity or to an upper layer RTP stack of the first network entity, the second RTP packet.

By including or configuring the communications manager 820 in accordance with examples as described herein, the device 805 may support techniques for improved communication reliability, reduced latency, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of RTP header compression for transport over a non-terrestrial network as described herein, or the at least one processor 835 and the at least one memory 825 may be otherwise configured to, individually or collectively, perform or support such operations.

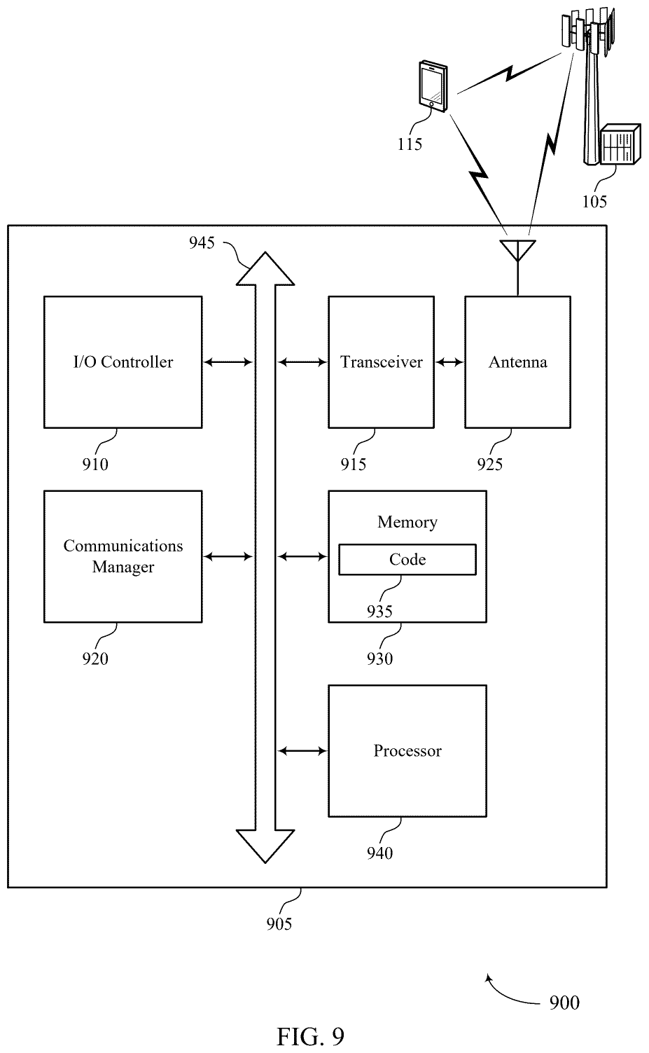

FIG. 9 shows a diagram of a system 900 including a device 905 that supports RTP header compression for transport over a non-terrestrial network in accordance with one or more aspects of the present disclosure. The device 905 may be an example of or include components of a device 505, a device 605, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an I/O controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 515, a transmitter 615, a receiver 510, a receiver 610, or any combination thereof or component thereof, as described herein.

The at least one memory 930 may include RAM and ROM. The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a BIOS which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting RTP header compression for transport over a non-terrestrial network). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving, from a second network entity supported by a non-terrestrial network, a first RTP packet including an audio payload associated with the second network entity, where the first RTP packet excludes one or more RTP header fields associated with a packet generation according to an RTP packet generation protocol. The communications manager 920 is capable of, configured to, or operable to support a means for generating at least one RTP header field of the one or more RTP header fields excluded from the first RTP packet based on exclusion of the one or more RTP header fields from the first RTP packet. The communications manager 920 is capable of, configured to, or operable to support a means for outputting, to a third network entity or to an upper layer RTP stack of the first network entity, a second RTP packet including both the audio payload associated with the second network entity and the at least one RTP header field generated by the first network entity.

Additionally, or alternatively, the communications manager 920 may support wireless communication in accordance with examples as disclosed herein. For example, the communications manager 920 is capable of, configured to, or operable to support a means for receiving, from a second network entity supported by a non-terrestrial network, a first RTP packet including an audio payload associated with the second network entity, where the first RTP packet includes one or more RTP header fields associated with a packet generation according to an RTP packet generation protocol. The communications manager 920 is capable of, configured to, or operable to support a means for generating a second RTP packet based on the first RTP packet, where the second RTP packet includes the audio payload and excludes one or more RTP header fields of the first RTP packet. The communications manager 920 is capable of, configured to, or operable to support a means for outputting, to a third network entity or to an upper layer RTP stack of the first network entity, the second RTP packet.

By including or configuring the communications manager 920 in accordance with examples as described herein, the device 905 may support techniques for improved communication reliability, reduced latency, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of RTP header compression for transport over a non-terrestrial network as described herein, or the at least one processor 940 and the at least one memory 930 may be otherwise configured to, individually or collectively, perform or support such operations.

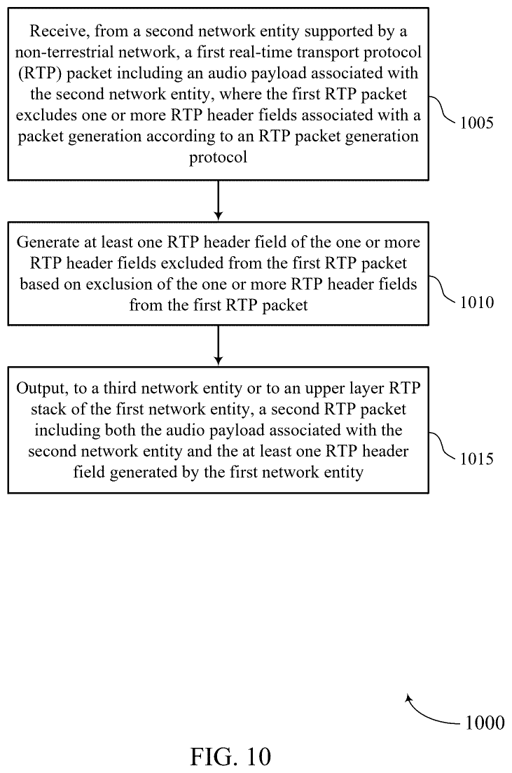

FIG. 10 shows a flowchart illustrating a method 1000 that supports RTP header compression for transport over a non-terrestrial network in accordance with one or more aspects of the present disclosure. The operations of the method 1000 may be implemented by or its components as described herein. For example, the operations of the method 1000 may be performed by. In some examples, may execute a set of instructions to control the functional elements of to perform the described functions. Additionally, or alternatively, may perform aspects of the described functions using special-purpose hardware.

At 1005, the method may include receiving, from a second network entity supported by a non-terrestrial network, a first RTP packet including an audio payload associated with the second network entity, where the first RTP packet excludes one or more RTP header fields associated with a packet generation according to an RTP packet generation protocol. The operations of 1005 may be performed in accordance with examples as disclosed herein.

At 1010, the method may include generating at least one RTP header field of the one or more RTP header fields excluded from the first RTP packet based on exclusion of the one or more RTP header fields from the first RTP packet. The operations of 1010 may be performed in accordance with examples as disclosed herein.

At 1015, the method may include outputting, to a third network entity or to an upper layer RTP stack of the first network entity, a second RTP packet including both the audio payload associated with the second network entity and the at least one RTP header field generated by the first network entity. The operations of 1015 may be performed in accordance with examples as disclosed herein.

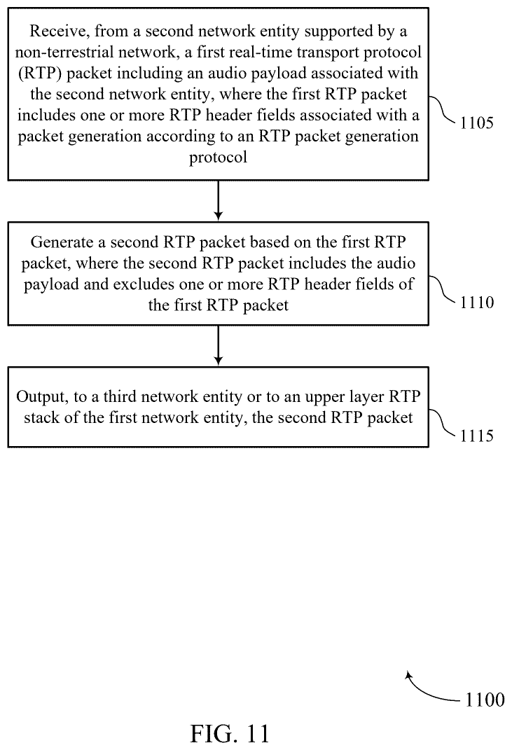

FIG. 11 shows a flowchart illustrating a method 1100 that supports RTP header compression for transport over a non-terrestrial network in accordance with one or more aspects of the present disclosure. The operations of the method 1100 may be implemented by or its components as described herein. For example, the operations of the method 1100 may be performed by. In some examples, may execute a set of instructions to control the functional elements of to perform the described functions. Additionally, or alternatively, may perform aspects of the described functions using special-purpose hardware.

At 1105, the method may include receiving, from a second network entity supported by a non-terrestrial network, a first RTP packet including an audio payload associated with the second network entity, where the first RTP packet includes one or more RTP header fields associated with a packet generation according to an RTP packet generation protocol. The operations of 1105 may be performed in accordance with examples as disclosed herein.

At 1110, the method may include generating a second RTP packet based on the first RTP packet, where the second RTP packet includes the audio payload and excludes one or more RTP header fields of the first RTP packet. The operations of 1110 may be performed in accordance with examples as disclosed herein.

At 1115, the method may include outputting, to a third network entity or to an upper layer RTP stack of the first network entity, the second RTP packet. The operations of 1115 may be performed in accordance with examples as disclosed herein.

The following provides an overview of aspects of the present disclosure:

Aspect 1: A method for wireless communication by a first network entity, comprising: receiving, from a second network entity supported by a non-terrestrial network, a first RTP packet comprising an audio payload associated with the second network entity, wherein the first RTP packet excludes one or more RTP header fields associated with a packet generation according to an RTP packet generation protocol; generating at least one RTP header field of the one or more RTP header fields excluded from the first RTP packet based at least in part on exclusion of the one or more RTP header fields from the first RTP packet; and outputting, to a third network entity or to an upper layer RTP stack of the first network entity, a second RTP packet comprising both the audio payload associated with the second network entity and the at least one RTP header field generated by the first network entity.

Aspect 2: The method of aspect 1, wherein receiving the first RTP packet comprises: receiving, in the first RTP packet, a compressed RTP header that excludes the one or more RTP header fields associated with the RTP packet generation protocol.

Aspect 3: The method of aspect 2, wherein the compressed RTP header has a data size of one byte or the compressed RTP header has the data size of zero.

Aspect 4: The method of any of aspects 2 through 3, wherein receiving the compressed RTP header comprises: receiving one or more bits indicating a synchronization source identifier of the first RTP packet.

Aspect 5: The method of any of aspects 2 through 4, wherein receiving the compressed RTP header comprises: receiving one or more bits associated with a sequence number of the first RTP packet.

Aspect 6: The method of any of aspects 2 through 5, wherein receiving the compressed RTP header comprises: receiving one or more bits associated with a payload type associated with the first RTP packet.

Aspect 7: The method of any of aspects 1 through 6, wherein the one or more RTP header fields excluded from the first RTP packet comprises at least one of an RTP version identifier parameter associated with the first RTP packet, a padding indication parameter associated with the first RTP packet, an extension indication parameter associated with the first RTP packet, a contributor count parameter associated with the first RTP packet, or any combination thereof.

Aspect 8: The method of any of aspects 1 through 7, wherein the one or more RTP header fields excluded from the first RTP packet comprises a timestamp parameter associated with the first RTP packet.

Aspect 9: The method of aspect 1, wherein the first RTP packet excludes an RTP header associated with the RTP packet generation protocol.

Aspect 10: The method of aspect 1, further comprising: transmitting, to the second network entity prior to receiving the first RTP packet, an indication of the one or more RTP header fields excluded from the first RTP packet.

Aspect 11: The method of aspect 1, wherein a variation in a time delay between a first time when the first RTP packet is transmitted by the second network entity and a second time when the first packet is received by the first network entity satisfies a threshold associated with an RTP packet interarrival duration.

Aspect 12: The method of aspect 1, wherein a voice call hold feature is unsupported based at least in part on exclusion of the one or more RTP header fields from the first RTP packet.

Aspect 13: The method of aspect 1, further comprising: refraining from transmitting RTCP feedback associated with the first RTP packet based at least in part on exclusion of the one or more RTP header fields from the first RTP packet.

Aspect 14: The method of aspect 1, further comprising: transmitting, via the non-terrestrial network, RTCP feedback associated with the first RTP packet, wherein the RTCP feedback is transmitted during a silence period of a voice call.

Aspect 15: The method of aspect 1, wherein generating the at least one RTP header field comprises: generating at least one of a sequence number of the first RTP packet, a time stamp of the first RTP header, synchronization source identifier of the first RTP packet, or any combination thereof.

Aspect 16: The method of aspect 1, wherein generating the at least one RTP header field comprises: generating an RTP version identifier parameter associated with the first RTP packet, a padding indication parameter associated with the first RTP packet, an extension indication parameter associated with the first RTP packet, a contributor count parameter associated with the first RTP packet, an end marker parameter associated with the first RTP packet, a payload type parameter associated with the first RTP packet, or any combination thereof.

Aspect 17: The method of any of aspects 1 through 16, wherein the first network entity is a user equipment, a network node, a base station, or a component of a disaggregated base station.

Aspect 18: A method for wireless communication by a first network entity, comprising: receiving, from a second network entity supported by a non-terrestrial network, a first RTP packet comprising an audio payload associated with the second network entity, wherein the first RTP packet comprises one or more RTP header fields associated with a packet generation according to an RTP packet generation protocol; generating a second RTP packet based at least in part on the first RTP packet, wherein the second RTP packet comprises the audio payload and excludes one or more RTP header fields of the first RTP packet; and outputting, to a third network entity or to an upper layer RTP stack of the first network entity, the second RTP packet.

Aspect 19: The method of aspect 18, wherein generating the second RTP packet comprises: generating, in the second RTP packet, a compressed RTP header that excludes the one or more RTP header fields.

Aspect 20: The method of aspect 19, wherein the compressed RTP header has a data size of one byte or the compressed RTP header has the data size of zero.

Aspect 21: The method of any of aspects 19 through 20, wherein generating the compressed RTP header comprises: generating one or more bits indicating a synchronization source identifier of the first RTP packet.

Aspect 22: The method of any of aspects 19 through 21, wherein generating the compressed RTP header comprises: generating one or more bits associated with a sequence number of the first RTP packet.

Aspect 23: The method of any of aspects 19 through 22, wherein generating the compressed RTP header comprises: generating one or more bits associated with a payload type associated with the first RTP packet.

Aspect 24: The method of aspect 18, wherein the one or more RTP header fields excluded of the first RTP packet comprises at least one of an RTP version identifier parameter associated with the first RTP packet, a padding indication parameter associated with the first RTP packet, an extension indication parameter associated with the first RTP packet, a contributor count parameter associated with the first RTP packet, or any combination thereof.

Aspect 25: The method of aspect 18, wherein the one or more RTP header fields excluded of the first RTP packet comprises a timestamp parameter associated with the first RTP packet.

Aspect 26: The method of aspect 18, wherein the second RTP packet excludes an RTP header associated with the RTP packet generation protocol.

Aspect 27: The method of aspect 18, wherein a voice call hold feature is unsupported based at least in part on exclusion of the one or more RTP header fields of the first RTP packet.

Aspect 28: The method of any of aspects 18 through 27, wherein the first network entity is a user equipment, a network node, a base station, or a component of a disaggregated base station.

Aspect 29: A first network entity for wireless communication, comprising one or more memories storing processor-executable code, and one or more processors coupled with the one or more memories and individually or collectively operable to execute the code to cause the first network entity to perform a method of any of aspects 1 through 17.

Aspect 30: A first network entity for wireless communication, comprising at least one means for performing a method of any of aspects 1 through 17.

Aspect 31: A non-transitory computer-readable medium storing code for wireless communication, the code comprising instructions executable by one or more processors to perform a method of any of aspects 1 through 17.

Aspect 32: A first network entity for wireless communication, comprising one or more memories storing processor-executable code, and one or more processors coupled with the one or more memories and individually or collectively operable to execute the code to cause the first network entity to perform a method of any of aspects 18 through 28.

Aspect 33: A first network entity for wireless communication, comprising at least one means for performing a method of any of aspects 18 through 28.

Aspect 34: A non-transitory computer-readable medium storing code for wireless communication, the code comprising instructions executable by one or more processors to perform a method of any of aspects 18 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories and individually or collectively operable to execute the code to cause the first network entity to:
receive, from a second network entity supported by a non-terrestrial network, a first real-time transport protocol (RTP) packet comprising an audio payload associated with the second network entity, wherein the first RTP packet excludes one or more RTP header fields associated with a packet generation according to an RTP packet generation protocol;
generate at least one RTP header field of the one or more RTP header fields excluded from the first RTP packet based at least in part on exclusion of the one or more RTP header fields from the first RTP packet; and
output, to a third network entity or to an upper layer RTP stack of the first network entity, a second RTP packet comprising both the audio payload associated with the second network entity and the at least one RTP header field generated by the first network entity.

2. The first network entity of claim 1, wherein, to receive the first RTP packet, the one or more processors are individually or collectively operable to execute the code to cause the first network entity to:
receive, in the first RTP packet, a compressed RTP header that excludes the one or more RTP header fields associated with the RTP packet generation protocol.

3. The first network entity of claim 2, wherein the compressed RTP header has a data size of one byte or the compressed RTP header has the data size of zero.

4. The first network entity of claim 2, wherein, to receive the compressed RTP header, the one or more processors are individually or collectively operable to execute the code to cause the first network entity to:
receive one or more bits indicating a synchronization source identifier of the first RTP packet.

5. The first network entity of claim 2, wherein, to receive the compressed RTP header, the one or more processors are individually or collectively operable to execute the code to cause the first network entity to:
receive one or more bits associated with a sequence number of the first RTP packet.

6. The first network entity of claim 2, wherein, to receive the compressed RTP header, the one or more processors are individually or collectively operable to execute the code to cause the first network entity to:
receive one or more bits associated with a payload type associated with the first RTP packet.

7. The first network entity of claim 1, wherein the one or more RTP header fields excluded from the first RTP packet comprises at least one of an RTP version identifier parameter associated with the first RTP packet, a padding indication parameter associated with the first RTP packet, an extension indication parameter associated with the first RTP packet, a contributor count parameter associated with the first RTP packet, a timestamp parameter associated with the first RTP packet, or any combination thereof.

8. The first network entity of claim 1, wherein the first RTP packet excludes an RTP header associated with the RTP packet generation protocol.

9. The first network entity of claim 1, wherein the one or more processors are individually or collectively further operable to execute the code to cause the first network entity to:
transmit, to the second network entity prior to receiving the first RTP packet, an indication of the one or more RTP header fields excluded from the first RTP packet.

10. The first network entity of claim 1, wherein a variation in a time delay between a first time when the first RTP packet is transmitted by the second network entity and a second time when the first packet is received by the first network entity satisfies a threshold associated with an RTP packet interarrival duration.

11. The first network entity of claim 1, wherein a voice call hold feature is unsupported based at least in part on exclusion of the one or more RTP header fields from the first RTP packet.

12. The first network entity of claim 1, wherein the one or more processors are individually or collectively further operable to execute the code to cause the first network entity to:
refrain from transmitting real-time transport control protocol (RTCP) feedback associated with the first RTP packet based at least in part on exclusion of the one or more RTP header fields from the first RTP packet.

13. The first network entity of claim 1, wherein the one or more processors are individually or collectively further operable to execute the code to cause the first network entity to:
transmit, via the non-terrestrial network, real-time transport control protocol (RTCP) feedback associated with the first RTP packet, wherein the RTCP feedback is transmitted during a silence period of a voice call.

14. The first network entity of claim 1, wherein, to generate the at least one RTP header field, the one or more processors are individually or collectively operable to execute the code to cause the first network entity to:
generate a sequence number of the first RTP packet, a time stamp of the first RTP header, synchronization source identifier of the first RTP packet, an RTP version identifier parameter associated with the first RTP packet, a padding indication parameter associated with the first RTP packet, an extension indication parameter associated with the first RTP packet, a contributor count parameter associated with the first RTP packet, an end marker parameter associated with the first RTP packet, a payload type parameter associated with the first RTP packet, or any combination thereof.

15. The first network entity of claim 1, wherein the first network entity is a user equipment, a network node, a base station, or a component of a disaggregated base station.

16. A first network entity, comprising:
one or more memories storing processor-executable code; and
one or more processors coupled with the one or more memories and individually or collectively operable to execute the code to cause the first network entity to:
receive, from a second network entity supported by a non-terrestrial network, a first real-time transport protocol (RTP) packet comprising an audio payload associated with the second network entity, wherein the first RTP packet comprises one or more RTP header fields associated with a packet generation according to an RTP packet generation protocol;
generate a second RTP packet based at least in part on the first RTP packet, wherein the second RTP packet comprises the audio payload and excludes one or more RTP header fields of the first RTP packet; and
output, to a third network entity or to an upper layer RTP stack of the first network entity, the second RTP packet.

17. The first network entity of claim 16, wherein, to generate the second RTP packet, the one or more processors are individually or collectively operable to execute the code to cause the first network entity to:
generate, in the second RTP packet, a compressed RTP header that excludes the one or more RTP header fields.

18. The first network entity of claim 17, wherein the compressed RTP header has a data size of one byte or the compressed RTP header has the data size of zero.

19. The first network entity of claim 16, wherein the one or more RTP header fields excluded of the first RTP packet comprises at least one of an RTP version identifier parameter associated with the first RTP packet, a padding indication parameter associated with the first RTP packet, an extension indication parameter associated with the first RTP packet, a contributor count parameter associated with the first RTP packet, a timestamp parameter associated with the first RTP packet, or any combination thereof.

20. A method for wireless communication by a first network entity, comprising:
receiving, from a second network entity supported by a non-terrestrial network, a first real-time transport protocol (RTP) packet comprising an audio payload associated with the second network entity, wherein the first RTP packet excludes one or more RTP header fields associated with a packet generation according to an RTP packet generation protocol;
generating at least one RTP header field of the one or more RTP header fields excluded from the first RTP packet based at least in part on exclusion of the one or more RTP header fields from the first RTP packet; and
outputting, to a third network entity or to an upper layer RTP stack of the first network entity, a second RTP packet comprising both the audio payload associated with the second network entity and the at least one RTP header field generated by the first network entity.
